(19) United States
(12) Patent Application Publication
(10) Pub. No.: US 2026/0178391 A1
(43) Pub. Date: Jun. 25, 2026

(54) Knowledge Graph Authorization

(71) Applicant: ServiceNow, Inc., Santa Clara, CA (US)

(72) Inventors: Raghavan Muthuraman, Chennai (IN); Jebakumar Mathuram Santhosam Swvigaradoss, Telangana (IN); Muthukumaran Raveendiran, Hyderabad (IN); Dhara Kotecha, Hyderabad (IN); Debasish Kanhar, Odisha (IN); Sakshi Kataria, Hyderabad (IN)

(21) Appl. No.: 18/999,009

(22) Filed: Dec. 23, 2024

(51) Int. Cl. G06F 9/50

(52) U.S. Cl. CPC G06F 9/5027

(57) ABSTRACT

A computer-implemented method for determining access to resources using a knowledge graph includes obtaining a knowledge graph with multiple nodes connected by edges and receiving a request for a requestor to access a resource. The requestor is associated with a first node, and the resource is associated with a second node within the knowledge graph. The method includes determining a path between the first and second nodes and evaluating each node along the path. For each node, the method determines an access control list (ACL) stored separately from the knowledge graph and verifies the requestor's access based on the ACL. Based on determining that the requestor has access to all nodes along the path, the method includes determining that the requestor has access to the second node. The method includes returning, to the requestor, a response indicating access to the resource.

### TECHNICAL FIELD

This disclosure relates to authorization in knowledge graphs.

### BACKGROUND

Knowledge graphs are widely used in various domains to represent and manage complex relationships between entities. These graphs consist of nodes, which represent entities, and edges, which represent the relationships between these entities. Knowledge graphs are particularly useful in scenarios where data interconnectivity and relationship mapping are crucial, such as in social networks, recommendation systems, and enterprise data management. However, by default, knowledge graphs do not inherently provide mechanisms for securing access to the data they represent.

Access Control Lists (ACLs) are a conventional method used to manage permissions and secure access to resources in various systems. These ACLs specify which users or system processes are granted access to objects, as well as what operations are allowed on given objects. In the context of knowledge graphs, ACLs can be implemented in different ways, such as by creating separate nodes for ACLs or by establishing edges labeled with access permissions. These methods, however, often require prior knowledge of access permissions and can be cumbersome to manage, especially in dynamic environments where access permissions frequently change.

### SUMMARY

One embodiment of the disclosure provides a computer-implemented method for providing knowledge graph authorization. The method includes obtaining a knowledge graph including a plurality of nodes connected via a plurality of edges. The method also includes obtaining a request for a requestor to access a resource, the requestor associated with a first node of the plurality of nodes of the knowledge graph, the resource associated with a second node of the plurality of nodes of the knowledge graph. The method includes determining a path through the knowledge graph between the first node and the second node. For each respective node along the path, the method includes determining a respective access control list (ACL) governing the respective node, the respective ACL stored separate from the knowledge graph and determining, using the respective ACL, that the requestor has access to the respective node. The method also includes, based on determining that the request has access to each respective node along the path, determining that the requestor has access to the second node. The method includes returning, to the requestor, a response indicating that the requestor has access to the second node.

Implementations of the disclosure may include one or more of the following optional features. In some implementations, the resource is further associated with a third node of the plurality of nodes. In some of these implementations, the method further includes determining a second path through the knowledge graph between the first node and the third node. The method may then further include determining, based on a respective ACL governing a respective node along the second path, that the requestor does not have access to the respective node along the second path and, based on determining that the requestor does not have access to the respective node along the second path, filtering the third node from the response. Optionally, the method further includes determining, based on a respective ACL governing a respective node along the second path, that the requestor does have access to the respective node along the second path and, based on determining that the requestor does have access to the respective node along the second path, adding an indication to the response that the requestor has access to the third node.

In some examples, the respective ACL for at least one respective node includes a row-based ACL. The respective ACL for at least one respective node may include a column-based ACL. The respective ACL for at least one respective node may include a script that dynamically executes based on determining the path. Optionally, the method further includes adjusting the respective ACL for at least one respective node without changing the knowledge graph. Each respective ACL for each respective node, in some examples, implements group-based access control for the resource.

Another embodiment of the disclosure provides a system for knowledge graph authorization. The system includes data processing hardware and memory hardware in communication with the data processing hardware. The memory hardware stores instructions that when executed on the data processing hardware cause the data processing hardware to perform operations. The operations include obtaining a knowledge graph including a plurality of nodes connected via a plurality of edges. The operations also include obtaining a request for a requestor to access a resource, the requestor associated with a first node of the plurality of nodes of the knowledge graph, the resource associated with a second node of the plurality of nodes of the knowledge graph. The operations include determining a path through the knowledge graph between the first node and the second node. For each respective node along the path, the operations include determining a respective access control list (ACL) governing the respective node, the respective ACL stored separate from the knowledge graph and determining, using the respective ACL, that the requestor has access to the respective node. The operations also include, based on determining that the request has access to each respective node along the path, determining that the requestor has access to the second node. The operations include returning, to the requestor, a response indicating that the requestor has access to the second node.

Implementations of the disclosure may include one or more of the following optional features. In some implementations, the resource is further associated with a third node of the plurality of nodes. In some of these implementations, the operations further include determining a second path through the knowledge graph between the first node and the third node. The operations may then further include determining, based on a respective ACL governing a respective node along the second path, that the requestor does not have access to the respective node along the second path and, based on determining that the requestor does not have access to the respective node along the second path, filtering the third node from the response. Optionally, the operations further include determining, based on a respective ACL governing a respective node along the second path, that the requestor does have access to the respective node along the second path and, based on determining that the requestor does have access to the respective node along the second path, adding an indication to the response that the requestor has access to the third node.

Another embodiment of the disclosure provides a computer-readable medium having instructions that, when executed by data processing hardware, causes the data processing hardware to perform operations. The operations include obtaining a knowledge graph including a plurality of nodes connected via a plurality of edges. The operations also include obtaining a request for a requestor to access a resource, the requestor associated with a first node of the plurality of nodes of the knowledge graph, the resource associated with a second node of the plurality of nodes of the knowledge graph. The operations include determining a path through the knowledge graph between the first node and the second node. For each respective node along the path, the operations include determining a respective access control list (ACL) governing the respective node, the respective ACL stored separate from the knowledge graph and determining, using the respective ACL, that the requestor has access to the respective node. The operations also include, based on determining that the request has access to each respective node along the path, determining that the requestor has access to the second node. The operations include returning, to the requestor, a response indicating that the requestor has access to the second node.

The details of one or more implementations of the disclosure are set forth in the accompanying drawings and the description below. Other embodiments, features, and advantages will be apparent from the description and drawings, and from the claims.

### DESCRIPTION OF DRAWINGS

FIG. 1 is a schematic view of an example system for knowledge graph authorization.

FIGS. 2A and 2B are schematic views of node-based access knowledge graphs.

FIGS. 3A and 3B are schematic views of edge-based access knowledge graphs.

FIG. 4 is a schematic view of a knowledge graph of the system of FIG. 1.

FIG. 5 is a flowchart of an example arrangement of operations for a method for knowledge graph authorization.

FIG. 6 is a schematic view of an example computing device that may be used to implement the systems and methods described herein.

Like reference symbols in the various drawings indicate like elements.

### DETAILED DESCRIPTION

In enterprise environments, managing access to resources represented in knowledge graphs poses significant challenges. Some methods of implementing ACLs in knowledge graphs involve either creating separate nodes for ACLs or establishing edges with access labels. These methods necessitate prior knowledge of access permissions and can lead to inefficiencies, especially when access permissions are dynamic and subject to frequent changes. For example, access permissions may be determined at runtime using complex scripts, making it impractical to predefine all possible access relationships within the graph.

Implementations herein address these challenges by dynamically applying ACLs to knowledge graphs without modifying the graph structure. The implementations involve traversing the knowledge graph to determine a path between a requestor (e.g., a user, a process, or any other entity) and a resource, and then verifying access permissions for each node along the path using ACLs stored separately from the graph. By decoupling the ACLs from the graph structure, these implementations allow the knowledge graph to remain static, thereby reducing the need for frequent updates and improving performance.

These implementations offer several technical advantages and benefits. For example, the need for prior knowledge of access permissions is eliminated, allowing for more flexible and dynamic access control. Moreover, the complexity of managing ACLs in knowledge graphs is reduced, as the access control logic is handled separately from the graph structure. As another example, performance is improved by minimizing the need for graph regeneration and enabling efficient runtime access control checks. Additionally, the implementations support complex ACL scenarios, such as script-based ACLs, which are difficult to implement using some static methods. This is particularly beneficial in enterprise systems where access permissions are not only based on static attributes but also on dynamic conditions that can change frequently. By leveraging a separate ACL layer, the system can efficiently determine access permissions on-the-fly, ensuring that only authorized users can access the requested resources.

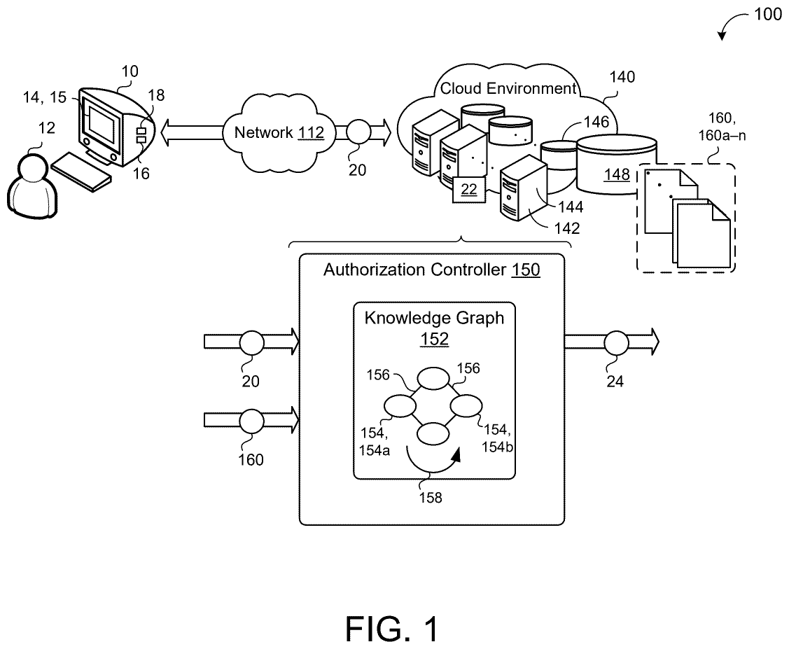

Referring to FIG. 1, in some implementations, an access control system 100 includes a remote system 140 in communication with one or more user devices 10 each associated with a respective user 12 via a network 112, such as the Internet, a local area network (LAN), a wide area network (WAN), a cellular network, or a wireless network. The remote system 140 may be a single computer, multiple computers, or a distributed system (e.g., a cloud environment) having scalable/elastic resources 142 including computing resources 144 (e.g., data processing hardware) and/or storage resources 146 (e.g., memory hardware). A data store 148 (i.e., a remote storage device) may be overlain on the storage resources 146 to allow scalable use of the storage resources 146 by one or more of the clients (e.g., the user device 10) or the computing resources 144.

The remote system 140 is configured to communicate with the user device 10 via, for example, the network 112. The user device(s) 10 may correspond to any computing device, such as a desktop workstation, a laptop workstation, or a mobile device (i.e., a smart phone). Each user device 10 includes computing resources 18 (e.g., data processing hardware) and/or storage resources 16 (e.g., memory hardware). The data processing hardware 18 may execute a graphical user interface (GUI) 15 for display on a screen 14 in communication with the data processing hardware 18. The GUI 15 may be provided by a web browser, a web application, a native application, or a hybrid application running on the user device 10. The GUI 15 may allow the user to create, edit, manage, or access resources, such as files, databases, or devices, using the remote system 140.

The remote system 140, in some implementations, executes an authorization controller 150 that the user device 10 communicates with via the network 112. The authorization controller 150 is a software application or module that is configured to perform access control based on a knowledge graph 152. The authorization controller 150 may interact with other software applications or modules that provide the GUI 15 or the resources, such as a web server, a web application, a native application, or a hybrid application. Some or all the authorization controller 150, in some examples, executes on the user device 10 in lieu of or in addition to the remote system 140.

The authorization controller 150 obtains or receives a knowledge graph 152 that includes a plurality of nodes 154 connected via a plurality of edges 156. The knowledge graph 152 may be stored in the data store 148 or in another storage device accessible by the authorization controller 150. The knowledge graph 152 is a structured representation of data that captures the relationships between different entities in a network. It consists of node 154s, which represent entities or resources (e.g., people, network devices, locations, etc.) and edges, which represent the relationships between these entities. Here, the knowledge graph 152 may represent data and relationships about the users 12, the resources, and the context of resource requests. For example, the knowledge graph 152 may include nodes 154 representing users 12, locations, devices, files, databases, etc., and edges 156 representing relationships or properties, such as located in, owns, accesses, etc. The knowledge graph 152 may be used to integrate, manage, and query data in a way that is both human-readable and machine-interpretable, enabling more efficient data retrieval and analysis.

The authorization controller 150 obtains or receives a request 20 for a requestor 12 to access a resource 22, such as a database, a file server, a virtual machine, or any other resource governed by the system 100. While examples herein show the requestor as the user 12, the requestor may be any other entity, such as an application executing on the remote system 140 or a third-party application or entity with a request.

The request 20 may be received from the user device 10 via the network 112. The request 20 optionally includes relevant information such as a user identifier that identifies the requestor 12, a resource identifier that identifies the requested resource 22, and/or a request type (e.g., access request, data retrieval request, service request, change request, etc.). For example, the request 20 indicates that user 1 wants to read file A, or that user 2 wants to update database B. The requestor 12 is associated with a first of the nodes 154, 202A of the knowledge graph 152, and the resource 22 is associated with a second of the nodes 154, 202B of the knowledge graph 152. For example, the first node 202A may represent the user 12 who makes the request 20, and the second node 202B may represent the file, the database, or the device that is the target of the request 20.

The authorization controller 150 determines a path 158 through the knowledge graph 152 between the first node 202A and the second node 202B. The path 158 is a sequence of nodes 154 and edges 156 that connect the first node 202A and the second node 202B. In some examples, the authorization controller 150 determines all possible paths 158 that connect the first node 202A and the second node 202B. In some examples, the path 158 is determined using various algorithms or heuristics, such as shortest path, longest path, most relevant path, etc. The path 158 may reflect the context or the semantics of the request 20, the knowledge graph 152, or an access control policy. For example, the path 158 may include nodes 154 and edges 156 that indicate the location, the role, the group, the device, the time, the frequency, or the history of the requestor 12 or the resource 22.

For each respective node 154 along the path 158, the authorization controller 150 determines a respective access control list (ACL) 160, 160a-n governing the respective node 154. Each respective ACL 160 is stored separate from the knowledge graph 152 and may be stored in the data store 148 or in another storage device accessible by the authorization controller 150. In some examples, each node 154 is associated with a single ACL 160, while in other examples, a node 154 is associated with multiple ACLs 160. The respective ACL(s) 160 defines the access rights of the respective node 154 for different requestors 12, resources 22, or request types. The respective ACL 160 may include various rules, conditions, or parameters that specify who can access what and how. In some implementations, the respective ACL 160 includes at least one of a row-based ACL, a column-based ACL, or a script that dynamically executes based on the path 158.

Row-based ACLs control access at the level of individual rows in a database table, allowing specific users or groups to access only certain rows. For instance, a row-based ACL might permit a sales manager to view only the sales records of their own team. Column-based ACLs, on the other hand, restrict access to specific columns within a table, ensuring that users can, for instance, only see the data relevant to their role. For example, a column-based ACL might allow an HR employee to view employee names and positions but not their salaries. Scripts that dynamically execute based on the path 158 provide a more flexible and context-sensitive approach to access control. These scripts can evaluate the requestor's permissions in real-time, considering the specific path taken through the knowledge graph. For example, a script may grant access to a document only if the requestor 12 has passed through a series of nodes 154 that verify their clearance level. The respective ACL 160 additionally or alternatively implements group-based access control for the resource 22, where the access rights are determined by the membership or the role of the requestor 12 in a group.

The authorization controller 150 determines, using the respective ACL(s) 160, that the requestor 12 has access to the respective node 154. When multiple ACLs 160 are associated with a single node 154, the authorization controller 150 may need to verify each ACL 160 permits the requestor 12 access. The authorization controller 150 may apply the respective ACL 160 to the request 20, the requestor, the resource, or the request type, and evaluate whether the requestor satisfies the rules, conditions, or parameters of the respective ACL 160. For example, the authorization controller 150 may check whether the requestor is the owner of the respective node 154, whether the requestor belongs to a group that has access to the respective node 154, whether the requestor has the appropriate role or permission to access the respective node 154, whether the request type is allowed for the respective node 154, etc.

If the authorization controller 150 determines that the requestor 12 does not have access to any node 154 along the path 158, the authorization controller 150 may abandon the path 158 by not continuing to check other nodes 154. If other paths 158 are still under consideration (i.e., ACLs 160 associated with the nodes 154 along the other paths 158 have not yet indicated the requestor 12 does not have access), the authorization controller 150 may still pursue those paths 158. When all paths 158 have at least one node 154 that the requestor 12 does not have access to, the authorization controller 150 may indicate to the requestor 12 that the request 20 is denied.

Based on determining that the requestor 12 has access to each respective node 154 along the path 158, the authorization controller 150 determines that the requestor 12 has access to the second node 202B. The authorization controller 150 may infer that the requestor 12 has access to the resource 22 associated with the second node 202B, based on the validity of the path 158 and the respective ACLs 160. The authorization controller 150 returns, to the requestor, a response 24 indicating that the requestor has access to the second node 202B (and, by association, the resource 22). The response 24 may be sent to the user device 10 via the network 112. The response 24 may include a message, a notification, a confirmation, or a result of the request 20. For example, the response 24 may indicate that the requestor can read, write, update, or delete the file, the database, or the device associated with the second node 202B.

In some implementations, the resource 22 is further associated with one or more additional nodes 154 of the knowledge graph 152. The authorization controller 150 may further determine additional paths 158 through the knowledge graph 152 between the first node 202A and each of the additional nodes 154. The additional paths 158 may be determined using the same or different algorithms or heuristics as the first path 158. The additional paths 158 may include nodes 154 and edges 156 that are different from or overlapping with the first path 158.

In some implementations, the authorization controller 150 determines, based on a respective ACL 160 governing a respective node 154 along the path 158, that the requestor does not have access to the respective node 154 along the second path 158. The authorization controller 150 may apply the respective ACL 160 to the request 20, the requestor 12, the resource, or the request type, and evaluate whether the requestor 12 satisfies the rules, conditions, or parameters of the respective ACL 160. For example, the authorization controller 150 may check whether the requestor 12 is the owner of the respective node 154, whether the requestor 12 belongs to a group that has access to the respective node 154, whether the requestor 12 has the appropriate role or permission to access the respective node 154, whether the request type is allowed for the respective node 154, etc.

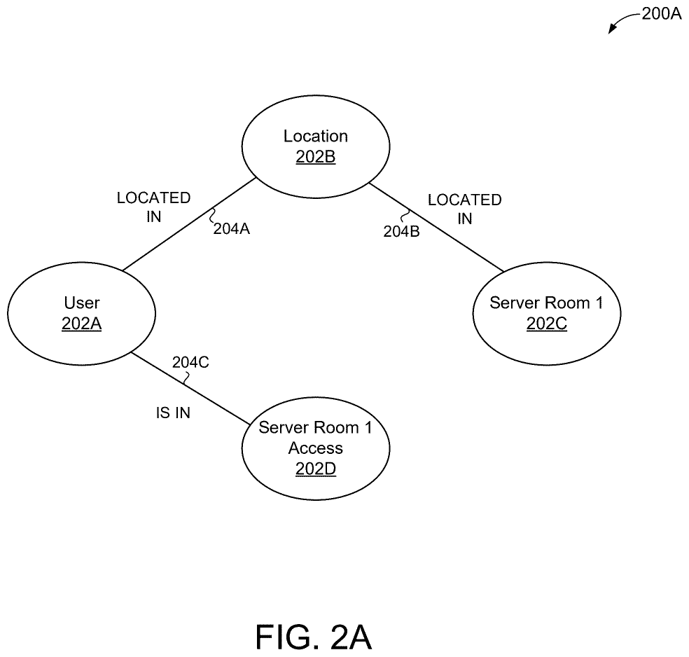

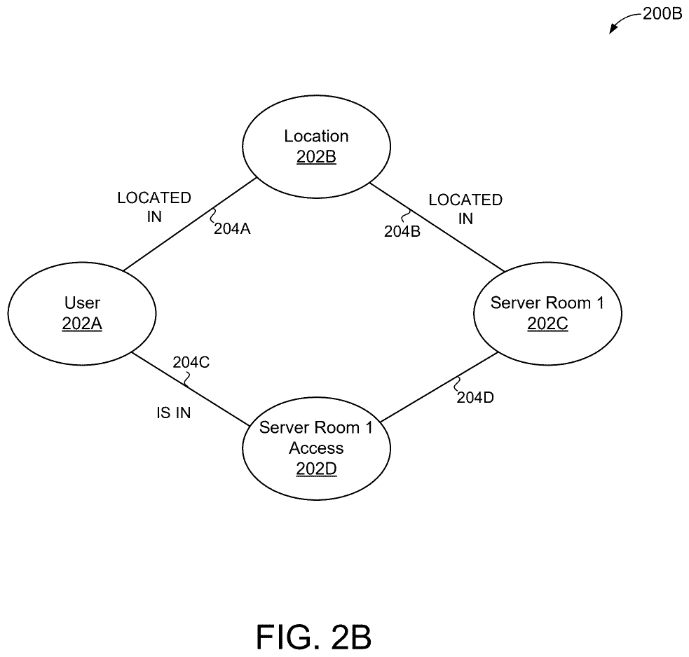

Referring to FIGS. 2A and 2B, an example of conventional node-based access control is depicted. FIG. 2A includes a knowledge graph 200A with four nodes 202A-D. The first node 202A is labeled “user,” the second node 202B is labeled “location,” the third node 202C is labeled “server room 1,” and the fourth node 202D is labeled “server room 1 access.” The user node 202A is connected to the location node 202B via an edge 204A labeled “located in.” The server room 1 node 202C is connected to the location node 202B via an edge 204B labeled “located in.” The user node 202A is connected to the server room 1 access node 202D via an edge 204C labeled “is in.”

In this example, the user does not have access to server room 1 because there is not an authorization or access node 154 (i.e., the node 202D) connecting the user node 202A and the server room 1 node 202C. That is, the lack of an edge 156 connecting the server room 1 access node 202D and the server room 1 node 202C indicates that the user does not have access to the server room 1 (the resource 22 in this example). Put another way, the access rights are determined by the presence or absence of nodes 154 in the knowledge graph 200A. This approach can be rigid and inflexible, as it requires the knowledge graph 200A to be updated whenever a new node 154 is added or removed, or whenever the access rights change. Moreover, this approach can be inefficient and inaccurate, as it may require traversing the entire knowledge graph 152 to find the relevant nodes.

FIG. 2B illustrates a knowledge graph 200B with the same four nodes 202A-D and three edges 204A-C as the knowledge graph 200A of FIG. 2A. However, the knowledge graph 200B also includes an edge 204D connecting the server room 1 node 202C with the server room 1 access node 202D. In this example, the user does have access to server room 1 because there is a node 154 connecting the user node 202A and the server room 1 node 202C. The access rights are determined by the presence or absence of nodes in the knowledge graph 200B. As discussed above, this approach is rigid and inflexible, as the knowledge graph 200B would need to be updated if, for example, the user's access to the server room 1 is revoked. Moreover, this approach is not conducive to applying ACL scripts dynamically, as to create the nodes requires prior knowledge of whether access is allowed, thus defeating the dynamic aspects of the script.

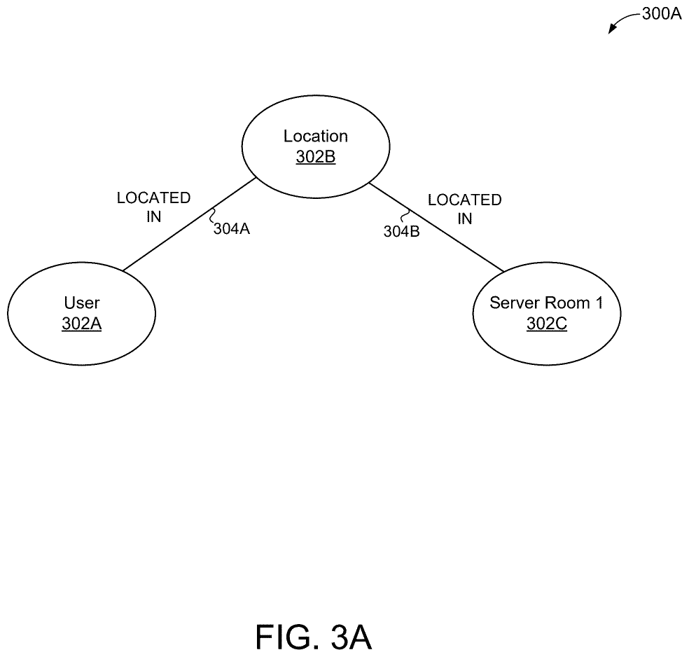

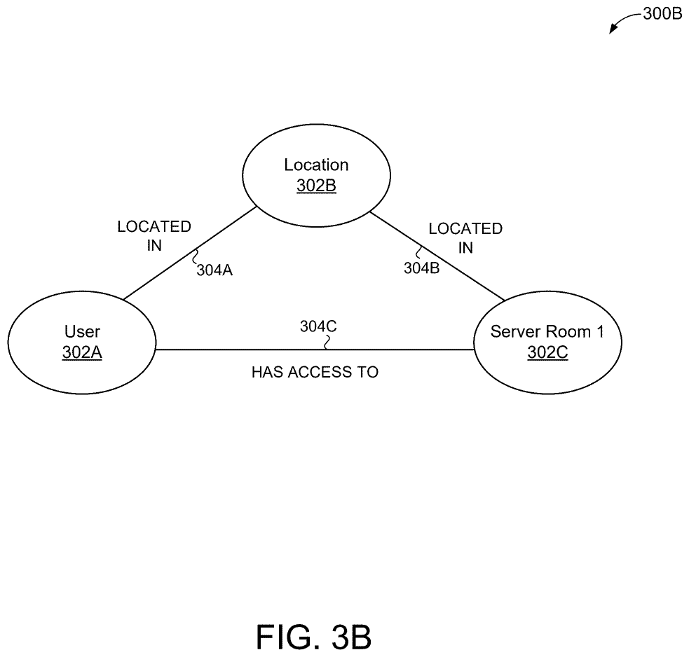

Referring to FIGS. 3A and 3B, an example of conventional edge-based access control is depicted. FIG. 3A includes a knowledge graph 300A with three nodes 302A-G. The first node 302A is labeled “user,” the second node 302B is labeled “location,” and the third node 302C is labeled “server room 1.” Here, the user node 302A and the location node 302B are connected via an edge 304A labeled “located in.” The location node 302B and the server room 1 node 306302C are connected via an edge 304B labeled “located in.” In this example, the user does not have access to the server room 1 because there is no edge 156 connecting the user node 302A and the server room 1 node 302C. The access rights are determined by the presence or absence of edges in the knowledge graph 300A.

This approach can be more flexible and efficient than node-based access control, as it allows for dynamic and granular access control based on the relationships between nodes. However, this approach can also be problematic, as it may require the knowledge graph 300A to have a large number of edges to capture all the possible access scenarios. Moreover, this approach can be inconsistent and ambiguous, as it may depend on the directionality and the semantics of the edges.

FIG. 3B illustrates a knowledge graph 300B that includes the same three nodes 302A-G and two edges 304A-F as the knowledge graph 300A of FIG. 3A.

However, the knowledge graph 300B also includes an edge 304C connecting the user node 302A and the server room 1 node 302C labeled “has access to.” This edge 304C grants the user access to the server room 1. Again, the access rights are determined by the presence or absence of edges in the knowledge graph 300B. Again, this approach requires the knowledge graph 300B to be updated to reflect changes in access. Moreover, this approach is not conducive to applying ACL scripts dynamically, as to create the edges requires prior knowledge of whether access is allowed, thus defeating the dynamic aspects of the script.

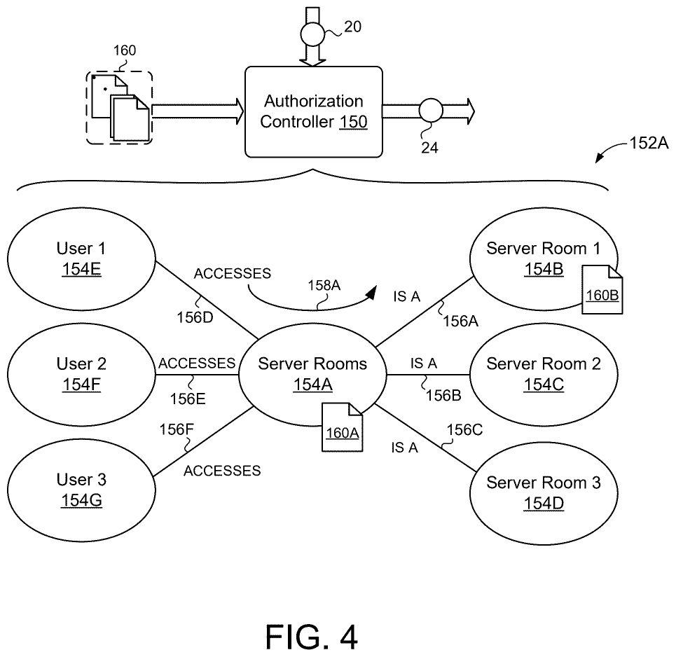

Referring to FIG. 4, a knowledge graph 152A as used by the authorization controller 150 is depicted. The knowledge graph 152 includes a server rooms node 154A connected to a server room 1 node 154B, a server room 2 node 154C, and a server room 3 node 154D, each connected via an edge 156A-C labeled “is a.” The server rooms node 154A also has a user 1 node 154E, a user 2 node 154F, and a user 3 node 154G each connected via edges 156D-F labeled “accesses.” The knowledge graph 152A represents data and relationships about the users and the server rooms.

In this example, the authorization controller 150 obtains a request 20 for user 1 to access server room 1. That is, the requestor 12 is associated with the user 1 node 154E, and the resource 22 is associated with the server room 1 node 154B. The authorization controller 150 determines a path 158A through the knowledge graph 152A between the user 1 node 154E and the server room 1 node 154B. The path 158A includes the user 1 node 154E, the server rooms node 154A, and the server room 1 node 154B, connected by the edge 156D and the edge 156A.

For each respective node 154 along the path 158A, the authorization controller 150 determines a respective ACL 160 governing the respective node 154. For example, the server rooms node 154A is associated with a first ACL 160A and the server room 1 node 154B is associated with a second ACL 160B. The respective ACLs 160A-B are stored separately from the knowledge graph 152A and define the access rights of the respective nodes 154A-B for different requestors 12, resources 22, or request types. For example, the ACL 160A for the server rooms node 154A specifies that user 1 can access server room 1 and server room 2, but not server room 3. The ACL 160B for the server room 1 node 154B may specify that user 1 can read and write files in server room 1, but not delete or update them. In this example, if the request 20 is to access server room 3 or to delete files in server room 1, the request 20 will be denied, as the request 20 does not satisfy both ACLs 160A-B. Alternatively, if the request 20 is to read files in server room 1, the request 20 may be granted, as the request 20 is authorized by both ACLs 160A-B.

The authorization controller 150 determines, using the respective ACLs 160A-B, whether the requestor has access to the respective nodes 154A-B. The authorization controller 150 applies the respective ACLs 160A-B to the request 20, the requestor 12, the resource 22, or the request type, and evaluates whether the requestor 12 satisfies the rules, conditions, or parameters of the respective ACLs 160A-B. For example, the authorization controller 150 checks whether the requestor 12 is user 1, whether the resource is server room 1, and whether the request type is read or write.

Based on determining that the requestor 12 has access to each respective node 154A-B along the path 158A, the authorization controller 150 determines that the requestor 12 has access to the server room 1 node 154B. The authorization controller 150 infers that the requestor 12 has access to the resource 22 associated with the server room 1 node 154B, based on the validity of the path 158A and the respective ACLs 160A-B. The authorization controller 150 returns, to the requestor 12, a response 24 indicating that the requestor 12 has access to the server room 1 node 154B. The response 24 may include a message, a notification, a confirmation, or a result of the request 20. For example, the response 24 may indicate that the requestor can read or write files in server room 1.

Based on determining that the requestor 12 does not have access to one or more of the nodes 154 along a particular path 158, the authorization controller 150 may filter the nodes 154 along that path 158 from the response 24. The authorization controller 150 may exclude or hide the resource 22 associated with the filtered nodes 154 from the requestor 12, based on the invalidity of the particular path 158 and the respective ACLs 160. Relating this to the example of FIG. 4, when the request 20 is a list of server rooms that user 1 may access, the authorization controller 150 may determine three paths 158 that each begin at the user 1 node 154E and end at the server room 1 node 154B, the server room 2 node 154C, and the server room 3 node 154D, respectively. When the ACL 160A indicates that user 1 does not have access to server room 3, the authorization controller 150 may filter the nodes 154 along that path (i.e., the server room 3 node 154D) and the subsequent resources 22 from the response 24. As another example, the authorization controller 150 may prevent the requestor 12 from accessing, viewing, or modifying the file, the database, or the device associated with server room 3.

Alternatively or additionally, the authorization controller 150 determines, based on a respective ACL 160 governing a respective node 154 along a path 158, that the requestor 12 does have access to a respective node 154 along a second path 158 (e.g., the server room 2 node 154C). In these implementations, the authorization controller 150 applies the respective ACL 160 to the request 20, the requestor 12, the resource 22, or the request type, and evaluates whether the requestor 12 satisfies the rules, conditions, or parameters of the respective ACL 160. For example, the authorization controller 150 may check whether the requestor is the owner of the respective node 154, whether the requestor 12 belongs to a group that has access to the respective node 154, whether the requestor 12 has the appropriate role or permission to access the respective node 154, whether the request type is allowed for the respective node 154, etc. Based on determining that the requestor 12 does have access to the respective node 154 along the second path 158, the authorization controller 150 adds an indication to the response 24 that the requestor 12 has access to the corresponding resource 22. The authorization controller 150 may include or highlight the resource 22 associated with the respective node 154 in the response 24, based on the validity of the second path 158 and the respective ACLs 160. For example, the authorization controller 150 may indicate that the requestor 12 can access, view, or modify the file, the database, or the device associated with the respective node 154.

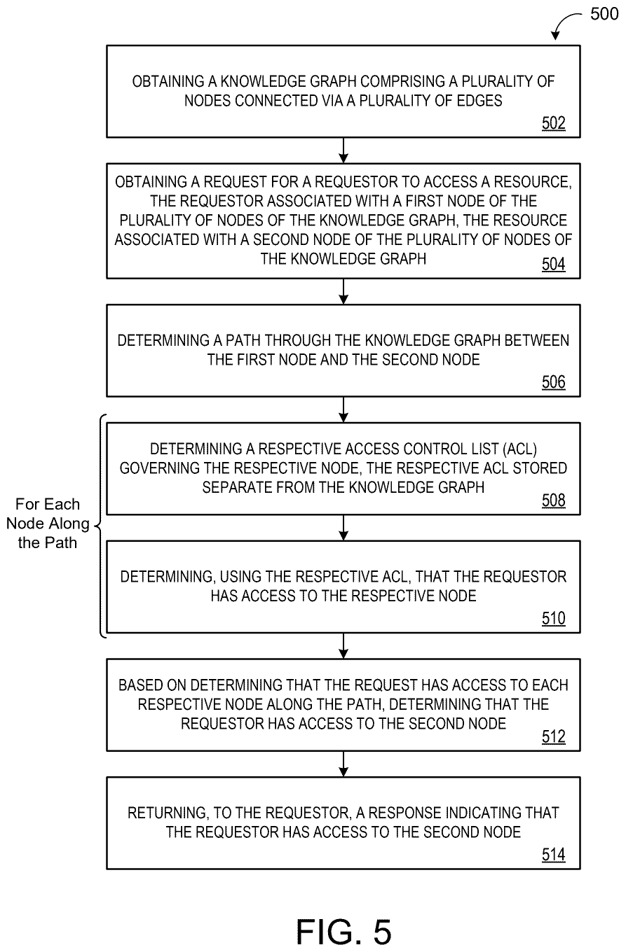

FIG. 5 is a flowchart of an exemplary arrangement of operations for a method 500 for providing knowledge graph authorization. The method 500 addresses challenges posed by conventional knowledge graph structures by dynamically applying ACLs to knowledge graphs without modifying the graph structure. The computer-implemented method 500, at operation 502, includes obtaining a knowledge graph 152 that includes a plurality of nodes 154 connected via a plurality of edges 156. The knowledge graph 152 may be stored in the data store 148 or in another storage device accessible by the authorization controller 150. The knowledge graph 152 may represent data and relationships about the users 12, the resources 22, and the context of the requests 20.

The method 500, at operation 504, includes obtaining a request 20 for a requestor 12 to access a resource 22. The request 20 may be received from the user device 10 via the network 112. The request 20 may include a user identifier, a resource identifier, and/or a request type. The requestor 12 is associated with a first node 154 of the knowledge graph 152, and the resource 22 is associated with a second node 154 of the knowledge graph 152.

The method 500, at operation 506, includes determining a path 158 through the knowledge graph 152 between the first node 154 and the second node 154. The path 158 is a sequence of nodes 154 and edges 156 that connects the first node 154 and the second node 154. The path 158 may be determined using various algorithms or heuristics, such as shortest path, longest path, most relevant path, etc. The path 158 may reflect the context or the semantics of the request 20, the knowledge graph 152, or an access control policy.

For each respective node 154 along the path 158, the method 500, at operation 508, includes determining a respective ACL 160 governing the respective node 154. Because the ACLs 160 are determined in real-time as the knowledge graph 152 is traversed, the need for prior knowledge of access permissions is eliminated, allowing for more flexible and dynamic access control. The respective ACL 160 is stored separate from the knowledge graph 152 and may be stored in the data store 148 or in another storage device accessible by the authorization controller 150. This reduces the complexity of managing ACLs in knowledge graphs, as the access control logic is handled separately from the graph structure. Moreover, performance is improved by minimizing the need for graph regeneration and enabling efficient runtime access control checks. The respective ACL 160 defines the access rights of the respective node 154 for different requestors 12, resources 22, or request types. The respective ACL 160 may include various rules, conditions, or parameters that specify who can access what and how.

The method 500, at operation 510, includes determining, using the respective ACL 160, that the requestor 12 has access to the respective node 154. By leveraging a separate ACL layer, the system can efficiently determine access permissions on-the-fly, ensuring that only authorized users can access the requested resources. The authorization controller 150 may apply the respective ACL 160 to the request 20, the requestor 12, the resource 22, or the request type, and evaluate whether the requestor 12 satisfies the rules, conditions, or parameters of the respective ACL 160. The method 500 supports complex ACL scenarios, such as script-based ACLs, which are difficult to implement using some static methods.

Based on determining that the requestor 12 has access to each respective node 154 along the path 158, the method 500, at operation 512, includes determining that the requestor 12 has access to the second node 154b. The authorization controller 150 may infer that the requestor 12 has access to the resource 22 associated with the second node 154, based on the validity of the path 158 and the respective ACLs 160. The method 500, at operation 514, includes returning, to the requestor 12, a response 24 indicating that the requestor 12 has access to the second node 154. The response 24 may include a message, a notification, a confirmation, or a result of the request 20.

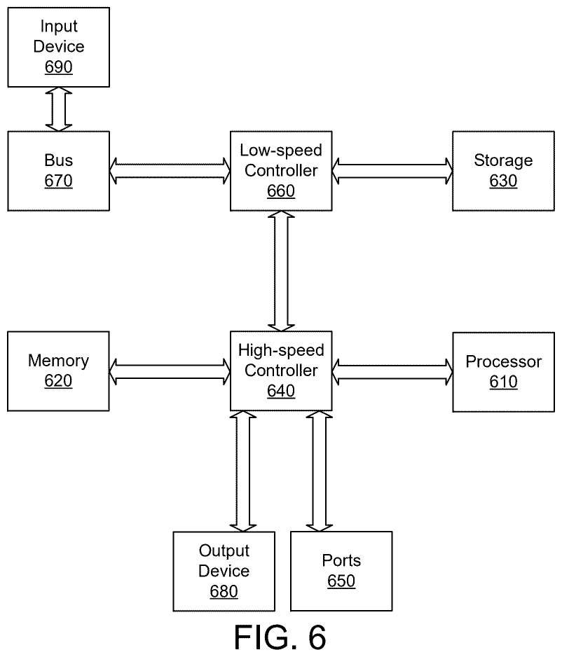

FIG. 6 is a schematic view of an example computing device 600 that may be used to implement the systems and methods described in this document. The computing device 600 is intended to represent various forms of digital computers, such as laptops, desktops, workstations, tablets, smartphones, servers, blade servers, mainframes, and other appropriate computers. The components shown here, their connections and relationships, and their functions, are meant to be illustrative only, and are not meant to limit implementations described and/or claimed in this document.

The computing device 600 includes a processor 610, memory 620, a storage device 630, a high-speed interface/controller 640 connecting to the memory 620 and high-speed expansion ports 650, and a low speed interface/controller 660 connecting to a low speed bus 670 and a storage device 630. Each of the components 610, 620, 630, 640, 650, and 660, are interconnected using various busses, and may be mounted on a common motherboard or in other manners as appropriate. The processor 610 can execute instructions for performing operations within the computing device 600, including instructions stored in the memory 620 or on the storage device 630 to display graphical information for a graphical user interface (GUI) on an external input/output device, such as display 680 coupled to high speed interface 640. In other implementations, multiple processors and/or multiple buses may be used, as appropriate, along with multiple memories and types of memory. Also, multiple computing devices 600 may be connected, with each device providing portions of the necessary operations (e.g., as a server cluster, a group of blade servers, or a multi-processor system).

The memory 620 stores information within the computing device 600. The memory 620 may be a non-transitory computer-readable medium, a volatile memory unit(s), or non-volatile memory unit(s). The non-transitory memory 620 may be physical devices used to store programs (e.g., sequences of instructions) or data (e.g., program state information) on a temporary or permanent basis for use by the computing device 600. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 630 is capable of providing mass storage for the computing device 600. In some implementations, the storage device 630 is a non-transitory computer-readable medium. In various different implementations, the storage device 630 may be a floppy disk device, a hard disk device, an optical disk device, or a tape device, a flash memory or other similar solid state memory device, or an array of devices, including devices in a storage area network or other configurations. In additional implementations, a computer program product is embodied in a non-transitory information carrier. The computer program product contains instructions that, when executed, perform one or more methods, such as those described above. The information carrier is a non-transitory computer-readable medium, such as the memory 620, the storage device 630, or memory on processor 610.

The high speed controller 640 manages bandwidth-intensive operations for the computing device 600, while the low speed controller 660 manages lower bandwidth-intensive operations. Such allocation of duties is exemplary only. In some implementations, the high-speed controller 640 is coupled to the memory 620, the display 680 (e.g., through a graphics processor or accelerator), and to the high-speed expansion ports 650, which may accept various expansion cards (not shown). In some implementations, the low-speed controller 660 is coupled to the storage device 630 and a low-speed expansion port 690. The low-speed expansion port 690, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 600a or multiple times in a group of such servers 600a, as a laptop computer 600b, or as part of a rack server system 600c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the term “non-transitory computer-readable medium” refers to any computer program product, apparatus and/or device (e.g., magnetic discs, optical disks, memory, Programmable Logic Devices (PLDs)) used to provide machine instructions and/or data to a programmable processor, including a non-transitory computer-readable medium that receives machine instructions as a non-transitory computer-readable signal. The term “non-transitory computer-readable signal” refers to any signal used to provide machine instructions and/or data to a programmable processor.

A software application (i.e., a software resource) may refer to computer software that instructs a computing device to perform a specific function or set of functions. A software application may be executed by a processor, a virtual machine, a web browser, or another software component on the computing device. In some examples, a software application may be referred to as an “application,” an “app,” a “program,” or a “service.” Example applications include, but are not limited to, system diagnostic applications, system management applications, system maintenance applications, word processing applications, spreadsheet applications, messaging applications, media streaming applications, social networking applications, gaming applications, e-commerce applications, cloud computing applications, artificial intelligence applications, and blockchain applications.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a non-volatile memory or a volatile memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Non-transitory computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method comprising:
obtaining a knowledge graph comprising a plurality of nodes connected via a plurality of edges;
obtaining a request for a requestor to access a resource, the requestor associated with a first node of the plurality of nodes of the knowledge graph, the resource associated with a second node of the plurality of nodes of the knowledge graph;
determining a path through the knowledge graph between the first node and the second node;
for each respective node along the path:
determining a respective access control list (ACL) governing the respective node, the respective ACL stored separate from the knowledge graph; and
determining, using the respective ACL, that the requestor has access to the respective node;
based on determining that the request has access to each respective node along the path, determining that the requestor has access to the second node; and
returning, to the requestor, a response indicating that the requestor has access to the second node.

2. The method of claim 1, wherein the resource is further associated with a third node of the plurality of nodes.

3. The method of claim 2, further comprising determining a second path through the knowledge graph between the first node and the third node.

4. The method of claim 3, further comprising:
determining, based on a respective ACL governing a respective node along the second path, that the requestor does not have access to the respective node along the second path; and
based on determining that the requestor does not have access to the respective node along the second path, filtering the third node from the response.

5. The method of claim 3, further comprising:
determining, based on a respective ACL governing a respective node along the second path, that the requestor does have access to the respective node along the second path; and
based on determining that the requestor does have access to the respective node along the second path, adding an indication to the response that the requestor has access to the third node.

6. The method of claim 1, wherein the respective ACL for at least one respective node comprises a row-based ACL.

7. The method of claim 1, wherein the respective ACL for at least one respective node comprises a column-based ACL.

8. The method of claim 1, wherein the respective ACL for at least one respective node comprises a script that dynamically executes based on determining the path.

9. The method of claim 1, further comprising adjusting the respective ACL for at least one respective node without changing the knowledge graph.

10. The method of claim 1, wherein each respective ACL for each respective node implements group-based access control for the resource.

11. A system comprising:
data processing hardware; and
memory hardware in communication with the data processing hardware, the memory hardware storing instructions that when executed on the data processing hardware cause the data processing hardware to perform operations comprising:
obtaining a knowledge graph comprising a plurality of nodes connected via a plurality of edges;
obtaining a request for a requestor to access a resource, the requestor associated with a first node of the plurality of nodes of the knowledge graph, the resource associated with a second node of the plurality of nodes of the knowledge graph;
determining a path through the knowledge graph between the first node and the second node;
for each respective node along the path:
determining a respective access control list (ACL) governing the respective node, the respective ACL stored separate from the knowledge graph; and
determining, using the respective ACL, that the requestor has access to the respective node;
based on determining that the request has access to each respective node along the path, determining that the requestor has access to the second node; and
returning, to the requestor, a response indicating that the requestor has access to the second node.

12. The system of claim 11, wherein the resource is further associated with a third node of the plurality of nodes.

13. The system of claim 12, further comprising determining a second path through the knowledge graph between the first node and the third node.

14. The system of claim 13, further comprising:
determining, based on a respective ACL governing a respective node along the second path, that the requestor does not have access to the respective node along the second path; and
based on determining that the requestor does not have access to the respective node along the second path, filtering the third node from the response.

15. The system of claim 13, further comprising:
determining, based on a respective ACL governing a respective node along the second path, that the requestor does have access to the respective node along the second path; and
based on determining that the requestor does have access to the respective node along the second path, adding an indication to the response that the requestor has access to the third node.

16. The system of claim 11, wherein the respective ACL for at least one respective node comprises a row-based ACL.

17. The system of claim 11, wherein the respective ACL for at least one respective node comprises a column-based ACL.

18. The system of claim 11, wherein the respective ACL for at least one respective node comprises a script that dynamically executes based on determining the path.

19. The system of claim 11, further comprising adjusting the respective ACL for at least one respective node without changing the knowledge graph.

20. A computer-readable medium having instructions that, when executed by data processing hardware, causes the data processing hardware to perform operations comprising:
obtaining a knowledge graph comprising a plurality of nodes connected via a plurality of edges;
obtaining a request for a requestor to access a resource, the requestor associated with a first node of the plurality of nodes of the knowledge graph, the resource associated with a second node of the plurality of nodes of the knowledge graph;
determining a path through the knowledge graph between the first node and the second node;
for each respective node along the path:
determining a respective access control list (ACL) governing the respective node, the respective ACL stored separate from the knowledge graph; and
determining, using the respective ACL, that the requestor has access to the respective node;
based on determining that the request has access to each respective node along the path, determining that the requestor has access to the second node; and
returning, to the requestor, a response indicating that the requestor has access to the second node.
